(19) United States
(12) Patent Application Publication
(10) Pub. No.: US 2016/0289130 A1
(43) Pub. Date: Oct. 6, 2016

(54) Mulch and Potting Soil Compositions Containing Microorganisms and Related Methods

(71) Applicant: BASF CORPORATION, Florham Park, NJ (US)

(72) Inventors: Peter INNES, Ames, IA (US); Rebecca LISTER, Ames, IA (US); Mark HOWIESON, Ankeny, IA (US)

(21) Appl. No.: 14/442,510

(22) PCT Filed: Nov. 15, 2013
(86) PCT No.: PCT/IB2013/060165

§ 371 Date: May 13, 2015

Related U.S. Application Data
(60) Provisional application No. 61/726,949, filed on Nov. 15, 2012.
(60) Provisional application No. 61/775,881, filed on Mar. 11, 2013.

(30) Foreign Application Priority Data
Mar. 11, 2013 (EP) 13158663.8

(51) Int. Cl. C05F 11/08; C05G 3/04; C09K 17/52

(52) U.S. Cl. CPC C05F 11/08; C09K 17/52; C05G 3/04

(57) ABSTRACT

The present invention relates to mulch or potting soil compositions that can enhance plant growth, water use efficiency of the plant, plant appearance, or the population of beneficial microorganisms or the content of metabolites produced by the beneficial microorganism in the mulch or soil around the plant. The compositions comprise mulch or potting soil and at least one microorganism, or a cell-free extract thereof or at least one metabolite thereof, and/or a mutant of the at least one microorganism having all the identifying characteristics of the respective microorganism or extract of the mutant.

### FIELD OF INVENTION

The various embodiments disclosed and contemplated herein relate to compositions comprising mulch or potting soil and at least one microorganism, or a cell-free extract thereof or at least one metabolite thereof, and/or a mutant of the at least one microorganism having all the identifying characteristics of the respective microorganism or extract of the mutant. Other embodiments can also include various other components, such as, for example, a carrier, a surfactant, a humectant, at least one biocide, a colorant, a binder, a dispersant, or a wetting agent. The various compositions can enhance plant growth, water use efficiency of the plant, plant appearance, or the population of beneficial microorganisms or the content of metabolites produced by the beneficial microorganism in the soil or mulch around the plant.

### BACKGROUND OF THE INVENTION

Mulch is a material that is applied as a layer to the surface of an area of soil, often around or in the vicinity of one or more plants. The mulch can be used to conserve moisture, improve fertility and health of the soil, reduce weed growth, and enhance visual appeal of the area. Potting soil is a mixture of organic material, drainage material, water retention, and pest resistant material, as well as the necessary nutrients that is applied as substrate in which to grow plants. The potting soil can be used to conserve moisture, improve fertility and health of the soil and to provide the optimal growing substrate for plants.

There is a need in the art for a composition comprising mulch or potting soil and at least one microorganism, or a cell-free extract thereof or at least one metabolite thereof, and/or a mutant of the at least microorganism having all the identifying characteristics of the respective microorganism or extract of the mutant.

### DETAILED DESCRIPTION

The various method and composition embodiments disclosed herein relate to mulch or potting soil containing one or more microorganisms.

Consequently, one embodiment relates to a mulch or potting soil composition comprising:
a) mulch or potting soil as component I; and
b) at least one microorganism, or a cell-free extract thereof or at least one metabolite thereof, and/or a mutant of the at least microorganism having all the identifying characteristics of the respective microorganism or extract of the mutant as component II.

The composition containing mulch or potting soil and at least one microorganism can enhance plant growth, water use efficiency of the plant, plant appearance, or the population of beneficial microorganisms in the soil around the plant. The embodiments disclosed and contemplated herein include various compositions comprising at least one type of mulch or one type of potting soil and at least one microorganism, various methods of making such compositions, and various methods of using or applying such compositions.

In one aspect, embodiments contemplated herein have produced unexpected results in enhancing plant growth, and water use efficiency of the plant by applying one or more microorganisms directly to the potting soil wherein the plant is growing. As such, those of skill in the art had no expectation that potting soil compositions containing at least one microorganism would have any beneficial effects on plants, and, as a result of the initial studies, actually had an expectation that it would not have such effects.

In another aspect, embodiments contemplated herein have produced unexpected results in enhancing plant growth, water use efficiency of the plant, and plant health by applying one or more microorganisms to mulch. Without being limited by theory, it was initially expected that mulch containing one or more microorganisms would effectively enhance plant growth and health and water use efficiency (or otherwise have beneficial effects as contemplated herein) only if the microorganisms came into relatively close proximity with the roots of the plants. More specifically, it was expected that application of water to the mulch would facilitate movement of microorganisms adsorbed to the treated mulch surface into the soil and ultimately be located in proximity to the plant roots, at which point the microorganisms could interact with the roots and cause the expected beneficial effects. However, initial studies performed in which water was applied to a mulch composition containing at least one microorganism indicated that the microorganisms in the mulch did not flow with the water into the soil. As a result, it was expected that the lack of movement of the microorganisms from the mulch composition into proximity with the roots meant that the mulch composition would have no beneficial effect on plants. Further, it was known to those skilled in the art at the time of the invention that mulch is beneficial because it retains water, but it was not thought of as or expected to be a soil enhancer. As such, those of skill in the art had no expectation that mulch compositions containing at least one microorganism would have any beneficial effects on plants, and, as a result of the initial studies, actually had an expectation that it would not have such effects.

The term “plant health” is to be understood to denote a condition of the plant and/or its products which is determined by several indicators alone or in combination with each other such as yield (e.g. increased biomass and/or increased content of valuable ingredients), plant vigor (e.g. improved plant growth and/or greener leaves (“greening effect”)), quality (e.g. improved content or composition of certain ingredients) and tolerance to abiotic and/or biotic stress. The above identified indicators for the health condition of a plant may be interdependent, or may result from each other.

However, it was subsequently and unexpectedly discovered, as explained herein, that the application of a mulch or potting soil composition containing at least one microorganism does have beneficial effects on plants. The exact mechanism producing these surprising results has not yet been identified. Without being limited by theory, it is hypothesized that the at least one microorganism may create a biologically active environment in the mulch that results in the development of biochemically active substances responsible for the beneficial effects on plant growth and development.

For purposes of this application, it is understood that “mulch” means any material applied to the surface of an area of soil for any number of purposes, including plant growth enhancement, moisture conservation, improvement of soil health and fertility, weed growth reduction, or visual appeal enhancement. Mulch can include any type of biodegradable natural fiber, including wood, paper, grass, hay, straw, pellets, organic residues, rubber, plastic, or rock and gravel. In certain embodiments, the mulch can be wood mulch from wood of any type, including hardwood, softwood, or recycled wood. The wood mulch can be ground wood mulch of any grind size or mix of grind sizes or chipped wood mulch of any chip size or mix of chip sizes. The pellet mulch can be made up of natural fiber pellets or any other known pellet for a mulch product. According to certain implementations, the organic residue mulch can be made of grass clippings, leaves, hay, straw, shredded bark, whole bark nuggets, sawdust, shells, woodchips, shredded newspaper, cardboard, or any other known organic residue used in mulch products. In one embodiment, the rubber mulch can be made from recycled tire rubber or any other known type or source of rubber that is used in mulch products. Further, the plastic sheet mulch can be any known mulch product in the form of a plastic sheet, including, for example, the type of plastic sheet mulch used in large-scale vegetable farming. In certain embodiments, mulch is any functional ground cover.

For purposes of this application, it is understood that “potting soil” also known as potting mix, or potting compost, means any material or medium in which to grow plants. Some common ingredients used in potting soil are peat, composted bark, soil, sand, sandy loam (combination of sand, soil and clay), perlite or vermiculate and recycled mushroom compost or other aged compost products although many others are used and the proportions vary hugely. Most commercially available potting soils have their pH fine-tuned with ground limestone, some contain small amounts of fertilizer and slow-release nutrients. Potting soil recipes are known e.g. from U.S. 2004/0089042 A1. Commercially available potting soil is sterilized, in order to avoid the spread of weeds and plant-borne diseases. Packaged potting soil often is sold in bags ranging from 1 to 50 kg.

Mulch can include any type of biodegradable natural fiber, including wood, paper, grass, hay, straw, pellets, organic residues, rubber, plastic, or rock and gravel. In certain embodiments, the mulch can be wood mulch from wood of any type, including hardwood, softwood, or recycled wood. The wood mulch can be ground wood mulch of any grind size or mix of grind sizes or chipped wood mulch of any chip size or mix of chip sizes. The pellet mulch can be made up of natural fiber pellets or any other known pellet for a mulch product. According to certain implementations, the organic residue mulch can be made of grass clippings, leaves, hay, straw, shredded bark, whole bark nuggets, sawdust, shells, woodchips, shredded newspaper, cardboard, or any other known organic residue used in mulch products. In one embodiment, the rubber mulch can be made from recycled tire rubber or any other known type or source of rubber that is used in mulch products. Further, the plastic sheet mulch can be any known mulch product in the form of a plastic sheet, including, for example, the type of plastic sheet mulch used in large-scale vegetable farming. In certain embodiments, mulch is any functional ground cover.

In one embodiment, the composition comprises mulch at least one microorganism or a combination of two or more microorganisms.

In another embodiment, the composition comprises potting soil and at least one microorganism or a combination of two or more microorganisms.

Component II embraces not only the isolated, pure cultures of the at least one microorganism or microorganism strain as defined herein, but also its cell-free extract, its suspensions in a whole broth culture or as a metabolite-containing supernatant or a purified metabolite obtained from a whole broth culture of the microorganism or microorganism strain.

“Whole broth culture” refers to a liquid culture containing both cells and media.

“Supernatant” refers to the liquid broth remaining when cells grown in broth are removed by centrifugation, filtration, sedimentation, or other means well known in the art.

The term “metabolite” refers to any compound, substance or byproduct produced by a microorganism (such as fungi and bacteria) that has improves plant growth, water use efficiency of the plant, plant health, plant appearance, or the population of beneficial microorganisms in the soil around the plant activity.

According to a further embodiment, component II embraces the at least one microorganism, and a cell-free extract thereof.

The term “mutant” refers a microorganism obtained by direct mutant selection but also includes microorganisms that have been further mutagenized or otherwise manipulated (e.g., via the introduction of a plasmid). Accordingly, embodiments include mutants, variants, and or derivatives of the respective microorganism, both naturally occurring and artificially induced mutants. For example, mutants may be induced by subjecting the microorganism to known mutagens, such as N-methyl-nitrosoguanidine, using conventional methods.

The composition comprises at least one microorganism or a combination of two or more microorganisms, or a cell-free extract thereof or at least one metabolite thereof, and/or a mutant of the at least microorganism having all the identifying characteristics of the respective microorganism or extract of the mutant as component II. In one embodiment, the at least one microorganism is a bacilli or a Gram-positive microorganism. In another embodiment, the one or more microorganisms can be selected from Bacillus amyloliquefaciens, B. amyloliquefaciens subsp. plantarum, B. cereus, B. firmus, B. megaterium, B. methylotrophicus, B. mojavensis, B. mycoides, B. psychrosaccharolyticus, B. pumilus, B. safensis, B. simplex, B. solisalsi, B. stratosphericus, B. subtilis, B. subtilis subsp. subtilis, Lysinibacillus boronitolerans, Microbacterium testaceum, Paenibacillus amylolyticus, P. barcinonensis, P. glycanilyticus, P. lautus, P. peoriae, P. polymyxa, P. taichungensis, P. xylanexedens, Solibacillus silvestris, Sporosarcina globispora, Sporosarcina psychrophila, Aspergillus flavus, Ampelomyces quisqualis, Aspergillus flavus, Aureobasidium pullulans, Candida oleophila, Candida saitoana, Clonostachys rosea f. catenulata, Coniothyrium minitans, Cryphonectria parasitica, Cryptococcus albidus, Fusarium oxysporum, Metschnikowia fructicola, Microdochium, Phlebiopsis gigantea, Pseudozyma flocculosa, Pythium oligandrum, Talaromyces flavus, Trichoderma asperellum, T. atroviride, T. harzianum, T. viride, T. polysporum, T. stromaticum, T. virens, T. viride and Ulocladium oudemansii.

In a further embodiment, the at least one microorganism can be chosen from fungi, especially from yeast-like fungi. In a further embodiment, the at least one microorganism is selected from the fungal genera Aspergillus, Aureobasidium, Cryptococcus, Fusarium, Trichoderma and Ulocladium.

In a further alternative, the at least one microorganism can be chosen from Bacillus aerophilus, Bacillus amyloliquefaciens, Bacillus amyloliquefaciens subsp. plantarum, Bacillus cereus, Bacillus firmus, Bacillus megaterium, Bacillus methylotrophicus, Bacillus mojavensis, Bacillus mycoides, Bacillus psychrosaccharolyticus, Bacillus pumilus, Bacillus safensis, Bacillus simplex, Bacillus solisalsi, Bacillus stratosphericus, Bacillus subtilis, Bacillus subtilis subsp. subtilis, Lysinibacillus boronitolerans, Microbacterium testaceum, Paenibacillus amylolyticus, Paenibacillus barcinonensis, Paenibacillus glycanilyticus, Paenibacillus lautus, Paenibacillus peoriae, Paenibacillus polymyxa, Paenibacillus taichungensis, Paenibacillus xylanexedens, Solibacillus silvestris, Sporosarcina globispora, or Sporosarcina psychrophila.

In a further embodiment, the at least one microorganism can be chosen from Aspergillus flavus (e.g. AFLAGUARD® from Syngenta, CH), Ampelomyces quisqualis (e.g. AQ 10® from Intrachem Bio GmbH & Co. KG, Germany), Aspergillus flavus (e.g. AFLAGUARD® from Syngenta, CH), Aureobasidium pullulans (e.g. BOTECTOR® from bio-ferm GmbH, Germany), Bacillus amyloliquefaciens (e.g. MBI600 under NRRL No. B-50595, also described as B. subtilis; in INTEGRAL® Becker Underwood, Inc., USA; see also U.S. 2012/0149571 A1), Bacillus firmus (e.g. Bacillus firmus of strain CNCM 1-1582, e.g. WO09126473A1 and WO09124707 A2, commercially available as “Votivo”), Bacillus pumilus (e.g. NRRL Accession No. B-30087 in SONATA® and BALLAD® Plus from AgraQuest Inc., USA; U.S. Pat. No. 6,635,245), Bacillus pumilus (e.g. NRRL No. B-50153; see U.S. 2012/0149571 A1), Bacillus subtilis (e.g. isolate NRRL-Nr. B-21661 (AQ713) in RHAPSODY®, SERENADE® MAX and SERENADE® ASO from AgraQuest Inc., USA), Bacillus subtilis FB17 (Planta (2007) 226: 283-297; WO 2011/109395 A2), Bacillus subtilis var. amyloliquefaciens FZB24 (e.g. TAEGRO® from Novozyme Biologicals, Inc., USA), Candida oleophila 1-82 (e.g. ASPIRE® from Ecogen Inc., USA), Candida saitoana (e.g. BIOCURE® (in mixture with lysozyme) and BIOCOAT® from Micro Flo Company, USA (BASF SE) and Arysta), Clonostachys rosea f. catenulata, also named Gliocladium catenulatum (e.g. isolate J1446: PRESTOP® from Verdera, Finland), Coniothyrium minitans (e.g. CONTANS® from Prophyta, Germany), Cryphonectria parasitica (e.g. Endothia parasitica from CNICM, France), Cryptococcus albidus (e.g. YIELD PLUS® from Anchor Bio-Technologies, South Africa), Fusarium oxysporum (e.g. BIOFOX® from S.I.A.P.A., Italy, FUSACLEAN® from Natural Plant Protection, France), Metschnikowia fructicola (e.g. SHEMER® from Agrogreen, Israel), Microdochium dimerum (e.g. ANTIBOT® from Agrauxine, France), Phlebiopsis gigantea (e.g. ROTSOP® from Verdera, Finland), Pseudozyma flocculosa (e.g. SPORODEX® from Plant Products Co. Ltd., Canada), Pythium oligandrum DV74 (e.g. POLYVERSUM® from Remeslo SSRO, Biopreparaty, Czech Rep.), Talaromyces flavus V117b (e.g. PROTUS® from Prophyta, Germany), Trichoderma asperellum SKT-1 (e.g. ECO-HOPE® from Kumiai Chemical Industry Co., Ltd., Japan), T. atroviride LC52 (e.g. SENTINEL® from Agrimm Technologies Ltd, NZ), T. harzianum T-22 (e.g. PLANTSHIELD® from BioWorks Inc., USA, TRIANUM-P from Koppert B. V., NL), T. harzianum TH 35 (e.g. ROOT PRO® from Mycontrol Ltd., Israel), T. harzianum T-39 (e.g. TRICHODEX® and TRICHODERMA 2000® from Mycontrol Ltd., Israel and Makhteshim Ltd., Israel), T. harzianum and T. viride (e.g. TRICHOPEL from Agrimm Technologies Ltd, NZ), T. harzianum ICC012 and T. viride ICC080 (e.g. REMEDIER® WP from Isagro Ricerca, Italy), T. polysporum and T. harzianum (e.g. BINAB® from BINAB Bio-Innovation AB, Sweden), T. stromaticum (e.g. TRICOVAB® from C.E.P.L.A.C., Brazil), T. virens GL-21 (e.g. SOILGARD® from Certis LLC, USA), T. viride (e.g. TRIECO® from Ecosense Labs. (India) Pvt. Ltd., Indien, BIO-CURE® F from T. Stanes & Co. Ltd., Indien), T. viride TV1 (e.g. T. viride TV1 from Agribiotec srl, Italy) and Ulocladium oudemansii HRU3 (e.g. BOTRY-ZEN® from Botry-Zen Ltd, NZ).

In a further embodiment, the at least one microorganism is selected from Bacillus amyloliquefaciens, B. cereus, B. firmus, B. megaterium, B. methylotrophicus, B. mojavensis, B. pumilus, B. simplex and B. subtilis.

In a further embodiment, the at least one microorganism is a microorganism strain, or a cell-free extract thereof or at least one metabolite thereof, and/or a mutant of the respective strain having all the identifying characteristics of the respective strain or extract of the mutant, selected from: Bacillus amyloliquefaciens MBI600 (also referred to as B. subtilis MBI600; U.S. 2012/0149571 A1), B. firmus CNCM 1-1582 (WO09126473A1 and WO09124707 A2), B. pumilus NRRL No. B-30087 (U.S. Pat. No. 6,635,245), B. pumilus NRRL No. B-50153 (U.S. 2012/0149571 A1), B. subtilis AQ713 (NRRL-No. B-21661, U.S. 2010/0209410 A1), B. subtilis FB17 (Planta (2007) 226: 283-297; WO 2011/109395 A2) and B. subtilis var. amyloliquefaciens FZB24 (U.S. Pat. No. 7,429,477),

In a further embodiment, the at least one microorganism is a microorganism strain, or a cell-free extract thereof or at least one metabolite thereof, and/or a mutant of the respective strain having all the identifying characteristics of the respective strain or extract of the mutant, selected from Bacillus subtilis AQ713 (NRRL-No. B-21661, U.S. 2010/0209410 A1), B. subtilis FB17 (Planta (2007) 226: 283-297; WO 2011/109395 A2) and B. subtilis var. amyloliquefaciens FZB24 (U.S. Pat. No. 7,429,477).

In a further embodiment, the at least one microorganism is a microorganism strain that is non-pathogenic to human.

In one embodiment, the at least one microorganism to be used in the composition is provided in a dry powder spore preparation. Alternatively, the microorganism is provided in a concentrated liquid form. In a further alternative, the microorganism is provided in water. In yet another alternative, the microorganism is provided in a formulated carrier (such as a carrier containing a surfactant). Alternatively, the at least one microorganism can be provided in any known form for use in a composition.

Various other components can be included in the composition. In one implementation, the composition contains mulch, at least one microorganism, or a cell-free extract thereof or at least one metabolite thereof, and/or a mutant of the at least one microorganism having all the identifying characteristics of the respective microorganism or extract of the mutant, and a carrier. In another implementation, the composition contains potting soil, at least one microorganism, or a cell-free extract thereof or at least one metabolite thereof, and/or a mutant of the at least one microorganism having all the identifying characteristics of the respective microorganism or extract of the mutant, and a carrier. The carrier can be a liquid carrier such as glycerine, water, a surface active agent (such as, for example, a wetting or dispersing agent), any other known liquid carrier, or any combination thereof. According to one embodiment, the carrier is a dry carrier. Examples of dry carriers include clay, kaolin clay, sodium bicarbonate, or any other known dry carrier. In a further embodiment, the carrier can be a composition of a polysiloxane; at least one polyalkylene glycol; and a co-product comprised of monopropylene glycol and a propylene oxide according to WO2010/104912 A1.

In a further alternative, the composition contains no carrier. In accordance with other embodiments, the composition contains mulch or potting soil, at least one microorganism, or a cell-free extract thereof or at least one metabolite thereof, and/or a mutant of the at least one microorganism having all the identifying characteristics of the respective microorganism or extract of the mutant, and at least one of the following: a humectant, at least one solvent (such as, for example, water, glycol, and/or mineral spirits), at least one preservative (such as, for example, a biocide), a colorant, a binder, a dispersant, a resin, or a wetting agent. In certain implementations, the colorant can be one or more paints or coatings, one or more powder coatings, one or more dispersions, one or more pigments, or one or more dyes. The binder can be any known polymer or resin such as, but not limited to, a water-based polymer or emulsion (such as an acrylic, polyvinylacetate, or polystyrene, for example), an oil-based polymer (such as an alkyd or a natural oil, like linseed or tung, for example), as well as other organic, inorganic, or hybrid polymers known to those skilled in the art.

In one particular embodiment, the composition comprises mulch or potting soil and about 0.01% to about 20% (w/w) of at least one microorganism, or a cell-free extract thereof or at least one metabolite thereof, and/or a mutant of the at least one microorganism having all the identifying characteristics of the respective microorganism or extract of the mutant, such as, for example, a microorganism spore preparation. Alternatively, the composition comprises at least one microorganism in an amount ranging from about 0.01% to about 10% (w/w). In a further alternative, the composition comprises at least one microorganism in an amount ranging from about 0.03% to about 3% (w/w). In a further alternative, the composition comprises at least one microorganism in an amount ranging from about 0.03% to about 0.3% (w/w). In alternative implementations, the composition can also comprise other components as discussed above in amounts constituting the balance of the composition.

The composition of at least one microorganism and any other components can be mixed with the mulch or the potting soil by any known mixing method to result in the microbially-enhanced mulch or potting soil composition. In one exemplary embodiment, the mulch or the potting soil, the microorganism, and any other components are mixed using a known paddle mixer. Alternatively, the components can be mixed using a tub grinder, a paint shaker, a soil blender, a ribbon blender, an auger screw (such as, for example, a single inline screw or multiple auger screws) a batch or feed mixer, a pug mill, a horizontal grinder, a trommel screen, a cement mixer, or physical mixing by hand.

According to one embodiment, the microbially-enhanced mulch composition can be applied as a layer to the soil around or in the vicinity of any number of different types of plants. For example, in one implementation, the composition can be applied to common landscape plants, including, but not limited to, trees, shrubs, woody ornamentals, herbaceous perennials, ornamental grasses and ground covers, ornamental bedding plants, vegetables, as well as plants grown for their fruits like blueberry, strawberry and raspberry. Further, it is understood that the microbially-enhanced mulch composition can be applied to any known plant that benefits from application of mulch. Alternatively, the composition can be applied as a layer to bare soil (where no plants are present). Alternatively, the mulch composition can be applied as a layer to soil in the vicinity of a location where a plant is to be grown (e.g. plant propagation material is sown). In one embodiment, the mulch composition is applied to the soil as a layer having a thickness ranging from about 0.5 to about 15 cm. Alternatively, the layer has a thickness ranging from about 2.5 to about 10 cm. In a further alternative, the layer has a thickness of at least 5 cm.

According to one embodiment, the microbially-enhanced potting soil composition as defined can be applied to soil and/or into a container, followed by planting one or more growing plants within the potting soil composition or sowing one or more plant propagation materials within the potting soil composition.

The terms “plant”, “plants” herein are to be understood as including but not be limited to cultivated plants, such as cereals, e.g. wheat, rye, barley, triticale, oats or rice; beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; sweet leaf (also called Stevie); natural rubber plants or horticultural or ornamental and forestry plants, such as flowers, shrubs, broad-leaved trees or evergreens, e.g. conifers; including the plant propagation material, such as seeds.

The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil.

The term “cultivated plants” is to be understood as including plants which have been modified by breeding, mutagenesis or genetic engineering including but not limiting to agricultural biotech products on the market or in development (cf. http://cera-gmc.org/, see GM crop data-base therein). Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-translational modification of protein(s), oligo- or polypeptides e. g. by glycosylation or polymer additions such as prenylated, acetylated or farnesylated moieties or PEG moieties.

In accordance with one implementation, the composition is applied such that an effective amount of the at least one microorganism would be in a range from about 1×10¹ CFU (colony forming units) per mL of (mulch or potting soil) composition to about 1×10⁹ CFU per mL of (mulch or potting soil) composition. Alternatively, the amount of microorganism would range from about 1×10² to about 1×10⁸ CFU per mL of (mulch or potting soil) composition. In a further alternative, the amount of microorganism can range from about 1×10² CFU per mL of mulch to about 1×10⁶ CFU per mL of (mulch or potting soil composition).

### EXAMPLE 1

In this example, a microbially-enhanced mulch composition was made and applied to certain potted plants (along with certain control compositions), and then the effect of the composition on shoot dry weight and water use efficiency of the plants was examined and compared to the controls.

### Preparation of the Composition

The microorganism used in this example was a strain of Bacillus subtilis which was supplied as a dry powder spore preparation. Using known standard culturing and plating techniques, the concentration of the Bacillus subtilis (expressed in colony forming units per gram (“CFU per gram”)) in the spore form was determined and used to calculate the amount needed to reach the target application rate for mulch for this example. The target rates for purposes of this example were 1×10⁴ and 1×10⁵ CFU per mL of mulch.

Generally, the microorganism was added to the mulch via water or colorant carrier then distributed over the mulch using a mechanical mixer (a paddle mixer). First, 14 L of mulch was added to the paddle mixer. The mulch used in this example was ground wood mulch—either non-sieved Missouri oak raw mulch from a wood grinder or Missouri oak fines (raw mulch run through a sieve of 0.6 cm width).

Next, 66% of the predetermined amount of tap water needed to wet out the specific mulch type was added. The amount of water depends on the condition of the mulch (including such factors as wood type, moisture, and grind size) and was provided in this example in sufficient volume to assure uniform distribution over the surface of the mulch. In this example, for the non-sieved mulch, the amount was 1000 mL per 14 L of mulch, while for the fines, it was 1400 mL per 14 L of mulch.

Then the Bacillus subtilis was added to the mixture. For purposes of this particular example, it was determined that either 1×10⁴ CFU per mL of mulch or 1×10⁵ CFU per mL of mulch could be added to achieve the appropriate amount. These amounts were identified using a “ladder” study to evaluate different application rates to identify efficient microorganism concentrations. More specifically, the appropriate amount of the Bacillus subtilis was measured into a 60 mL jar on an analytical balance. Next, 30 grams of tap water was added (from the remaining 34% of the water), and then the lid was attached and the jar was shaken well for 10 to 20 seconds. The mixture was then added from the jar to the mulch while mixing the mulch in the paddle mixer. The jar was then filled with water and the water added to the paddle mixer twice (a “double rinse”) using the remaining amount of water that did not exceed the total predetermined amount of water.

The composition was then allowed to mix for four minutes, was removed from the mixer, and then was allowed to air dry.

### Application of the Composition to Potted Plants—Trial Series no. 1

The composition was then tested for effectiveness on plants by applying the composition and several control compositions to potted plants. The plants were six- to eight-week old plants of Rudbeckia hirta ‘Indian Summer’, which were transplanted into 30.5 cm diameter thermoformed nursery pots, which were filled with a 45:45:10 mixture of soil:peat moss:sand.

The various compositions were applied to the pots to a depth of 7.5 cm. As indicated in Table 1 below, there were four different compositions applied to potted plants: (1) a Bacillus-treated mulch composition prepared as described above in this example, (2) a Bacillus-treated composition containing no mulch and applied as a “soil drench” in the equivalent water volume of 99 L drench per cubic meter of soil, (3) a mulch composition with no microorganism added, and (4) bare, untreated soil.

Following application of the test compositions, each pot was watered to excess three times over a 12-hour period and then allowed to drain for approximately 12 hours. After that 12-hour draining period, each pot was weighed and the mass was recorded as field capacity for that container.

The plants were maintained in the pots for six weeks. The pots were weighed once a week to measure the amount of water used since the previous irrigation. That weight was compared to the field capacity of the pot as determined above and then containers were irrigated back to field capacity based on a calculation of the difference between the field capacity and the weekly measure. At the time of each irrigation, the numbers of buds and flowers were also recorded.

After six weeks, the pots containers were destructively harvested and the shoot dry weight of each plant was measured. More specifically, the shoot dry weight was measured after placing the plant in a 68° C. oven for three days. In addition, water use efficiency (expressed as a ratio of total dry mass produced over the total water used) was calculated by using the formula: Water Use Efficiency=DW/ML, where DW equals shoot dry weight and ML equals total water used over the duration of the experiment.

TABLE 1

| | Shoot dry weight | Water use efficiency |
|---|---|---|
| Mulch/Soil | (g) | (mg DW per mL water) |
| Non-treated mulch | 16.0 | 2.4 |
| Bacillus treated mulch | 20.9 | 3.0 |
| Soil without mulch | 12.0 | 1.1 |
| (average of 2 controls) | | |
| Bacillus treated soil | 19.8 | 1.6 |
| (drench) | | |

### EXAMPLE 2

Six to eight week old plants of Rudbeckia hirta, Heliopsis, and Marigold were transplanted into 12 inch diameter thermoformed nursery pots. Nursery pots were filled with a 45:45:10 mixture of soil:peat moss:sand.

Appropriate mulch treatment was applied to pots to a depth of 3 inches. Following mulch application, each pot was watered to excess several times and then allowed to drain for approximately 12 hours. Each pot was then weighed and mass recorded as field capacity for that container.

Once a week, containers were weighed to determine water used since the last irrigation and containers were irrigated back to field capacity.

Six weeks after transplanting, containers were destructively harvested and shoot dry weight androot dry weightwere determined. Shoot dry weight was measured following three days in a 68° C. oven.

TABLE 2

| | | | | Water use |
|---|---|---|---|---|
| | | | | efficiency (mg |
| | | Shoot dry | Root dry | DW per mL |
| Mulch | Plant | weight (g) | weight (g) | water) |
| Non-treated | Heliopsis | 26.9 | 3.4 | 2.7 |
| mulch | | | | |
| Bacillus- | Heliopsis | 32.0 | 7.9 | 2.8 |
| treated mulch | | | | |
| Non-treated | Marigold | 8.1 | 3.0 | 1.8 |
| mulch | | | | |
| Bacillus- | Marigold | 10.5 | 3.9 | 1.9 |
| treated mulch | | | | |
| Non-treated | Rudbeckia | 34.3 | ND | 2.9 |
| mulch | | | | |
| Bacillus- | Rudbeckia | 59.7 | ND | 3.9 |
| treated mulch | | | | |

While multiple embodiments are disclosed, still other embodiments will become apparent to those skilled in the art from the following detailed description, which shows and describes illustrative embodiments of the inventions. As will be realized, the embodiments are capable of modifications in various obvious aspects, all without departing from the spirit and scope of the present inventions. Accordingly, the drawings and detailed description are to be regarded as illustrative in nature and not restrictive.

### Application of the Composition to Potted Plants—Trial Series no. 2

Approximately 4-8 week old rudbeckia, zinnia, and heliopsis seedlings were transplanted into 1 gallon nursery containers (12″ diameter) filled with modified garden soil (soil, peat moss, sand blend). The crops were used as indicated in Table 3.

As indicated in Table 4 below, there were three different compositions applied to potted plants to a depth of 3 inches: (1) a Bacillus-treated mulch composition prepared as described above in this example (referred to as “ treated mulch” in the following), wherein the application rate in this treatment delivered approximately 1 E+4 CFU Bacillus subtilis per mL of mulch, (2) a stand -and Missouri oak hardwood mulch with no microorganism added (referred to as “non-treated mulch” in the following), and (3) soil without mulch.

Following mulch treatment application, pots were saturated with water and allowed to drain for six to twelve hours. Each study was allowed the same amount of drainage time. Mass of each pot was recorded as field capacity.

Each week, pots were weighed and amount of water lost was recorded as difference between field capacity mass and pot mass prior to each irrigation. After mass was recorded, pots were irrigated back to saturation until water drained freely.

At the conclusion of the trial (approximately 4 weeks after transplanting), pots were photographed and destructively harvested. Shoot height (cm), and shoot dry weight (g) were measured directly, whereas water use efficiency (mg shoot dry weight per g of water lost over the duration of the trial) was calculated. The corresponding data are shown in Table 4.

At time of transplanting into nursery pots, soil in each pot was fertilized with 45 g of Osmocote 19-6-12.

TABLE 3

Crop

| | Rudbeckia | Zinnia | Heliopsis |
|---|---|---|---|
| Variety | Indian Summer | Inca | Summer Sun |
| Planting date: | 16-Apr-13 | 23-Apr-13 | 20-May-13 |
| Harvest date: | 14-May-13 | 22-May-13 | 18-Jun-13 |

TABLE 4
(greenhouse data summary):

| | | | Shoot | Water Use |
|---|---|---|---|---|
| | | Shoot | Dry | Efficiency |
| | | Height | Weight | (mg DW per |
| | | (cm) | (g) | mL water) |
| Rudbeckia | Soil without mulch | 43.4 | 11.0 | 1.6 |
| Rudbeckia | Non-treated Mulch | 48.3 | 9.3 | 2.3 |
| Rudbeckia | Treated Mulch | 57.1 | 11.6 | 3.8 |
| Zinnia | Soil without mulch | 35.6 | 5.3 | 1.2 |
| Zinnia | Non-treated Mulch | 40.4 | 6.2 | 2.3 |
| Zinnia | Treated Mulch | 48.8 | 9.2 | 2.4 |
| Heliopsis | Soil without mulch | 65.6 | 10.2 | 1.5 |
| Heliopsis | Non-treated Mulch | 69.5 | 10.8 | 2.4 |
| Heliopsis | Treated Mulch | 71.6 | 13.0 | 2.7 |

1-20. (canceled)

21. A mulch or potting soil composition comprising:
a) mulch or potting soil as component I; and
b) at least one microorganism, or a cell-free extract thereof or at least one metabolite thereof, and/or a mutant of the at least one microorganism having all the identifying characteristics of the respective microorganism or extract of the mutant, as component II.

22. The composition of claim 21 for enhancing plant growth, water use efficiency of the plant, plant appearance, or the population of beneficial microorganisms or the content of metabolites beneficial to plant health produced by the beneficial microorganisms in the mulch or soil around the plant.

23. The mulch composition of claim 21 comprising as component I mulch.

24. The potting soil composition of claim 21 comprising as component I potting soil.

25. The mulch or potting soil composition of claim 1, wherein the at least one microorganism of component II is selected from the group consisting of Bacillus amyloliquefaciens, B. amyloliquefaciens subsp. plantarum, B. cereus, B. firmus, B. megaterium, B. methylotrophicus, B. mojavensis, B. mycoides, B. psychrosaccharolyticus, B. pumilus, B. safensis, B. simplex, B. solisalsi, B. stratosphericus, B. subtilis, B. subtilis subsp. subtilis, Lysinibacillus boronitolerans, Microbacterium testaceum, Paenibacillus amylolyticus, P. barcinonensis, P. glycanilyticus, P. lautus, P. peoriae, P. polymyxa, P. taichungensis, P. xylanexedens, Solibacillus silvestris, Sporosarcina globispora, Sporosarcina psychrophila, Aspergillus flavus, Ampelomyces quisqualis, Aspergillus flavus, Aureobasidium pullulans, Candida oleophila, Candida saitoana, Clonostachys rosea f. catenulata, Coniothyrium minitans, Cryphonectria parasitica, Cryptococcus albidus, Fusarium oxysporum, Metschnikowia fructicola, Microdochium, Phlebiopsis gigantea, Pseudozyma flocculosa, Pythium oligandrum, Talaromyces flavus, Trichoderma asperellum, T. atroviride, T. harzianum, T. viride, T. polysporum, T. stromaticum, T. virens, T. viride and Ulocladium oudemansii.

26. The composition of claim 21, wherein the at least one microorganism of component II comprises a bacilli microorganism or a Gram-positive microorganism.

27. The composition of claim 26, wherein the at least one microorganism of component II comprises a bacterium of the genus Bacillus selected from the group consisting of Bacillus amyloliquefaciens, B. cereus, B. firmus, B. megaterium, B. methylotrophicus, B. mojavensis, B. pumilus, B. simplex and B. subtilis.

28. The composition of claim 27, wherein the at least one microorganism comprises Bacillus subtilis.

29. The composition claim 21, further comprising a carrier.

30. The composition of claim 29, further comprising at least one of a surfactant or a solvent.

31. The composition of claim 30, further comprising a colorant, a resin or binder and a preservative.

32. The composition of claim 1, wherein the mulch is wood mulch.

33. The composition of claim 21, wherein the at least one microorganism, or a cell-free extract thereof or at least one metabolite thereof, and/or a mutant of the at least one microorganism having all the identifying characteristics of the respective microorganism or extract of the mutant are present in an amount ranging from about 0.01% to about 10% (w/w) of the composition.

34. The composition of claim 21, wherein the at least one microorganism and/or a mutant of the at least one microorganism having all the identifying characteristics of the respective microorganism are present in an effective amount ranging from about 1×10¹ CFU per mL of the composition to about 1×10⁹ CFU per mL of the composition.

35. A method of making the composition of claim 21, the method comprising:
providing at least one microorganism in a dry powder spore preparation, a concentrated liquid form, or a formulated carrier; and
mixing a mulch or a potting soil and the least one microorganism into the composition.

36. The method of claim 35, the method further comprising mixing a carrier into the mulch or the potting soil or into the composition.

37. A method for enhancing plant growth, water use efficiency of the plant, plant appearance, or the population of beneficial microorganisms or the content of metabolites beneficial to plant health produced by the beneficial microorganisms in the mulch or soil around the plant, the method comprising:
applying a layer of the mulch composition of claim 21 to soil in the vicinity of a plant or a in the vicinity of a location where a plant is to be grown.

38. The method of claim 37, wherein the layer of the composition has a thickness from about 0.5 cm to about 15 cm.

39. A method for enhancing plant growth, water use efficiency of the plant, plant appearance, or the population of beneficial microorganisms or the content of metabolites beneficial to plant health produced by the beneficial microorganisms in the soil around the plant, the method comprising:
applying the potting soil composition of claim 21 to soil and/or into a container, and planting one or more growing plants or sowing one or more plant propagation materials within the potting soil composition.
